(19) United States
(12) Patent Application Publication
(10) Pub. No.: US 2004/0204053 A1
(43) Pub. Date: Oct. 14, 2004

(54) Wireless electronic memory device

(76) Inventor: Jen-Tsung Yeh, Taoyuan City (TW)

Correspondence Address: Jason Z. LIN, Supreme Patent Services, Post Office Box 2339, Saratoga, CA, 95070, US

(21) Appl. No.: 10/278,631

(22) Filed: Oct. 22, 2002

(51) Int. Cl. H04B 5/00; H04M 1/00; H04B 1/38

(52) U.S. Cl. 455/556.1; 455/41.1

(57) ABSTRACT

A wireless electronic memory device includes a transmitting/receiving unit connected to a processing module, which is in turn coupled to a memory unit via a memory bus. A portable data processing device includes a transmitting/receiving unit that sets up a wireless communication channel with the transmitting/receiving unit of the wireless memory device when the portable data processing device is located within a working range of the wireless memory device. The portable data processing device has an operation system that loads drive software in accordance with communication protocol recognizable by the processing module of the wireless memory device for properly transferring data between the wireless memory device and the portable data processing device thereby allowing the portable data processing device to access the memory unit of the wireless memory device.

### FIELD OF THE INVENTION

The present invention relates generally to an electronic memory device for a computer system, and in particular to an electronic memory device that is selectively and electrically coupled to and accessed by the computer system in a wireless manner.

### BACKGROUND OF THE INVENTION

With the trend of minimization that is prevailing in the electronic industry, many peripheral devices that were originally built in a computer system, such as a notebook computer, are now made separate from the computer system as stand-along peripheral devices. Thus, a computer system is detachably and selectively connected to a number of peripheral devices. Conventionally, the peripheral devices are connected to the computer system by connection cables through which data are transferred between the computer system and the peripheral devices. The increasing amount of data that the modern people confront requires the data transfer rate to be consistently increased. However, the cable based data transfer technology is somehow subject to the limitation of the capacity of the cable.

Further, most of the memory devices that are connected to a computer system constitute partly a computer network comprised of the computer system, rather than functioning as independent peripheral devices. This increases the expense of installation and maintenance of the network.

Examples of the electronic memory devices that are adapted in a portable data processing device, such as a notebook computer, are magnetic disk drive and optic disk drive. Originally, these disk drives are selectively mounted in the notebook computer as a built-in device. This increases the size and weight of the notebook computer and is against the trend of minimization. To overcome the problems, the disk drives are made separate from the notebook computer and may be connected to the notebook computer in a plug and play manner by for example USB technology. U.S. Pat. Nos. 4,894,792 and 6,199,122 disclose examples of such technology. However, the prior art technology requires cable connection between the peripheral device (or memory device) and the notebook computer.

The cable connection between peripheral devices and the computer system is subject to the limitation of different standards. Taking USB technology as an example, the USB standard supports two different data transfer rates, the low speed data transfer and the full speed data transfer. The low speed mode allows for only 1.5 Mbps data transfer rate, while the full speed scheme allows for up to 12 Mbps data transfer. The cable length of the low speed transfer is limited to 3.5 meters, while that for the full speed transfer is 5 meters. All these factors affect the data transfer between the peripheral devices and the notebook computer. In addition, with the development of high speed electronic devices, such as high speed optic disk drive, the data transfer rate between the peripheral device and the computer system is required to be up to 200 Mbps. This is far beyond the current cable based data transfer standard can take.

### SUMMARY OF THE INVENTION

Thus, an object of the present invention is to provide an electronic memory device that is wirelessly coupled to a data processing device for data storage without limitation caused by connection cables.

Another object of the present invention is to provide an electronic memory device that is a stand-along device rather than a networked memory.

To achieve the above objects, in accordance with the present invention, there is provided a wireless electronic memory device comprising a transmitting/receiving unit connected to a processing module, which is in turn coupled to a memory unit via a memory bus. A portable data processing device comprises a transmitting/receiving unit that sets up a wireless communication channel with the transmitting/receiving unit of the wireless memory device when the portable data processing device is located within a working range of the wireless memory device. The portable data processing device has an operation system that loads drive software in accordance with communication protocol recognizable by the processing module of the wireless memory device for properly transferring data between the wireless memory device and the portable data processing device thereby allowing the portable data processing device to access the memory unit of the wireless memory device.

### BRIEF DESCRIPTION OF THE DRAWINGS

The present invention will be apparent to those skilled in the art by reading the following description of a preferred embodiment thereof, with reference to the attached drawings, in which:

FIG. 1 is a schematic of an electronic memory device in accordance with the present invention wirelessly coupled to an electronic data processing device;

FIG. 2 is a block diagram of the electronic memory device of the present invention wirelessly coupled to the electronic data processing device;

FIG. 3 is a block diagram illustrating set-up of a wireless communication channel between the electronic memory device and the electronic data processing device; and

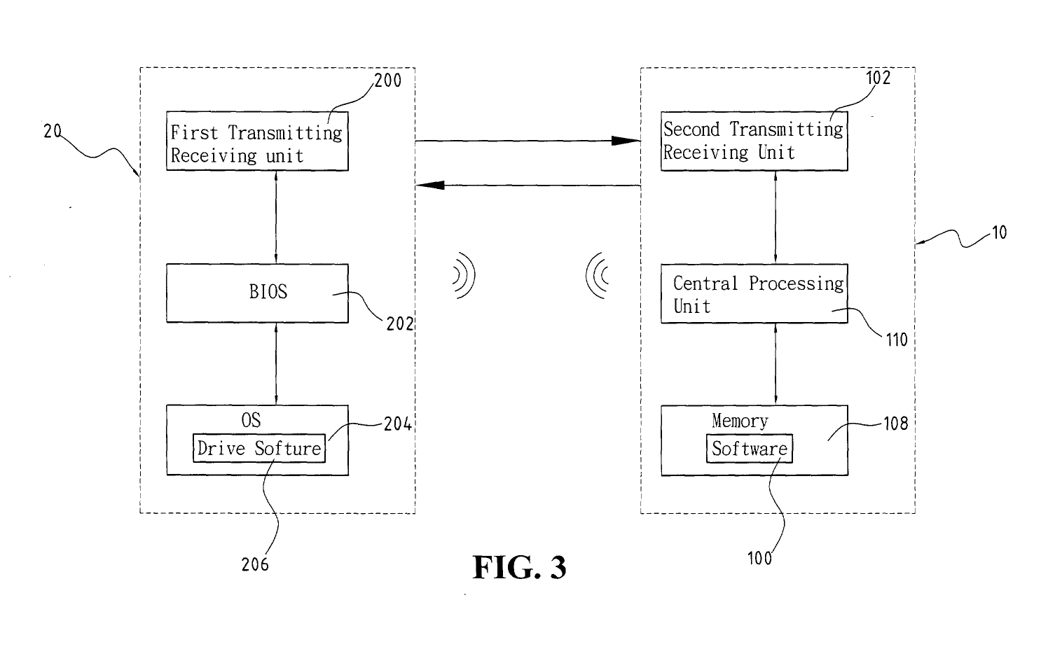

FIG. 4 is a block diagram of a central processing module of the electronic memory device of the present invention.

### DETAILED DESCRIPTION OF THE INVENTION

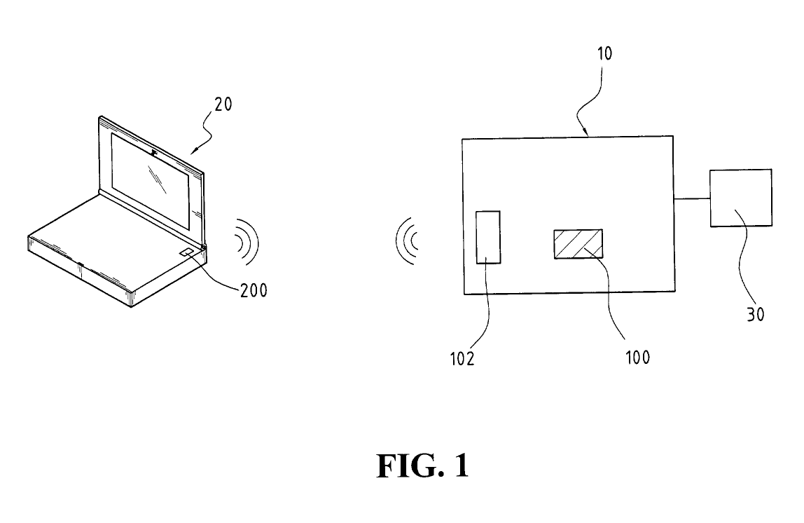

With reference to the drawings and in particular to FIG. 1, an electronic memory device in accordance with the present invention, generally designated with reference numeral 10, is wirelessly coupled to an electronic data processing device 20, such as a desktop computer, a notebook computer and a personal data assistant (PDA), to serve as an independent data storage for the electronic data processing device 20. It is apparent to those having ordinary skills to selectively and wirelessly couple the electronic data processing device 20 to a number of electronic memory devices 10 of the present invention. This allows for access of data stored in different storage devices by a single data processing device. It is also possible to allow for the access of a single memory device 10 of the present invention by a number of data processing devices 10.

To set up a wireless communication channel between the electronic data processing device 20 and the electronic memory device 10, a first transmitting/receiving unit 200 is built in the electronic data processing device 20 and a corresponding second transmitting/receiving unit 102 is formed with the electronic memory device 10. The first and second transmitting/receiving units 200, 102 transmit and receive electromagnetic signals that carry data and instruction to be transferred to and from each other thereby setting up the communication channel between the electronic data processing device 20 and the electronic memory device 10. Communication protocol adapted between the first and second transmitting/receiving units 200, 102 can be any known protocols, including, but not limited to, IEEE 802.11, IEEE 802.11a, IEEE 802.11b, IR (Infrared), bluetooth, GSM (Global System for Mobile communications), GPRS (General Packet Radio Service), and Home RF.

The electronic memory device 10 comprises a memory unit 30 electrically connected to the second transmitting/receiving unit 102. Thus, the data processing device 20 may access (read and write) data of the memory unit 30 via the communication channel between the first and second transmitting/receiving units 200, 102.

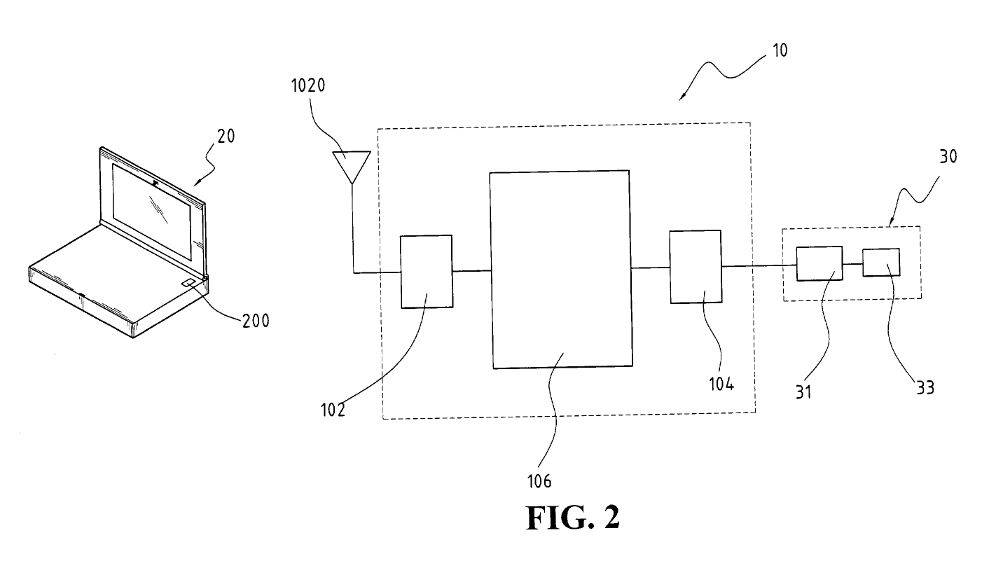

Also referring to FIG. 2, the electronic memory device 10 comprises a processing module 106 that is connected to the second transmitting/receiving unit 102. The processing module 106 is coupled to the memory unit 30 via a memory bus 104. The memory unit 30 comprises a data access device 31 and a data storage 33. The data access device 31 reads data from the data storage 33 and write data into the data storage 33 under the control of the processing module 106. Examples of the data storage 33 include, but not limited to, memory stick, flash memory card, optic disk, such as CD (Compact Disk) and DVD (Digital Video Disk), floppy magnetic disc, hard magnetic disc, MO (Magneto-Optic) disk and IC card. The data access device 31 is a device capable of accessing the specific type of data storage and thus the data access device 31 may be a memory stick reader, a flash memory card reader, an optic disk drive, including CD and DVD drive, a floppy disk drive, a hard disk drive, a MO disk drive and an IC card reader.

The memory bus 104 can be IDE, USB, PCI, PCMCIA or SCSI. The data storage 33 is selected to be compatible with the memory bus 104 in order to ensure proper data access. For example, if the memory bus 104 is an IDE bus, then the data storage 33 may be an IDE based hard disk drive.

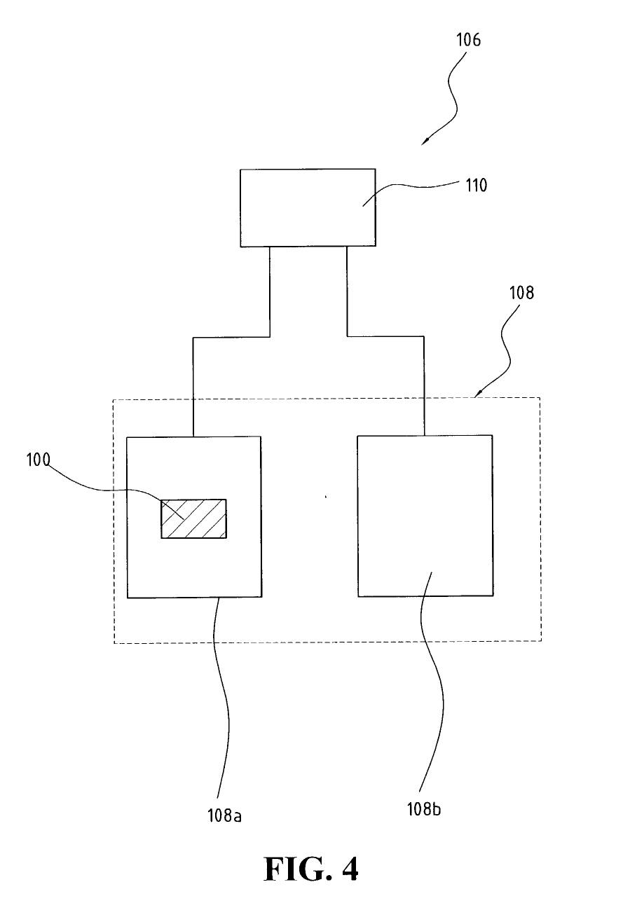

Also referring to FIG. 4, the processing module 106 comprises a central processing unit 110 to which memory means 108 is connected. The memory means 108 stores software 100 of the processing module 106 for operation of the processing unit 110. The software 100 may include program codes for communication protocol. The memory means 108 may comprise a read only memory 108a and a random access memory 108b. The read only memory 108a stores the operation software, while the random access memory 108b provides a temporary memory for the operation of the processing module 106. The random access memory 108b can be replaced by other type of memories, such as flash memory.

In use, when the data processing device 20 is moved into or located within a working range of the electronic memory device 10, the first transmitting/receiving unit 200 of the electronic data processing device 20 detects the second transmitting/receiving unit 102 of the electronic memory device 10 and determines the communication protocol therebetween. The first transmitting/receiving unit 200 then signals BIOS 202 of the electronic data processing device 20 which in turn controls the operation system 204 of the electronic data processing device 20 to install drive software 206 associated with the communication protocol. At the same time, the second transmitting/receiving unit 102 signals the processing module 110 to start the operating software 100 for setting up the communication channel between the first and second transmitting/receiving units 200, 102. Data may then be transferred between the electronic memory device 10 and the electronic data processing device 20.

The second transmitting/receiving unit 102 may further comprise an antenna 1020 for enhancement of data transfer between the first and second transmitting/receiving units 200, 102.

The central processing unit 110 of the electronic memory device 10 can be RISC or CISC type central processing unit. The operating software 100 of the central processing unit 110 can be for example Linux, Windows CE, Windows NT and Macintosh.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A wireless memory device for wirelessly coupling to a data processing device, the
wireless memory device:
a processing module;
a memory unit connected to the processing module by memory bus for storage of data to be accessed by the data processing device;
a wireless transmitting/receiving unit adapted to be wirelessly coupled to a transmitting/receiving unit of the data processing device to form a wireless communication channel therebetween;
wherein the processing module comprise a central processing unit and an internal memory storing program codes to be executed by the central processing unit for setting up the wireless communication channel.

2. The wireless memory device as claimed in claim 1, further comprising antenna means connected to the wireless transmitting/receiving unit of the wireless memory device.

3. The wireless memory device as claimed in claim 1, wherein the data processing device comprises an operation system controlling the data processing device to load and actuate drive software in order to establish the wireless communication channel with the wireless memory device in accordance with a communication protocol specified by the wireless memory device.

4. The wireless memory device as claimed in claim 1, wherein the memory unit comprises disk drive operable with data storage disk.

5. The wireless memory device as claimed in claim 1, wherein the memory unit comprises a memory stick.

6. The wireless memory device as claimed in claim 1, wherein the memory unit comprises an IC card.

7. The wireless memory device as claimed in claim 1, wherein the memory unit comprises a flash memory card.

8. The wireless memory device as claimed in claim 4, wherein the data storage disk comprises an optic disk.

9. The wireless memory device as claimed in claim 4, wherein the data storage disk comprises a magnetic disk.

10. The wireless memory device as claimed in claim 4, wherein the data storage disk comprises a magneto-optic disk.
